(19) United States
(12) Patent Application Publication
(10) Pub. No.: US 2016/0078380 A1
(43) Pub. Date: Mar. 17, 2016

(54) GENERATING CROSS-SKILL TRAINING PLANS FOR APPLICATION MANAGEMENT SERVICE ACCOUNTS

(71) Applicant: International Business Machines Corporation, Armonk, NY (US)

(72) Inventor: Ying Li, Mohegan Lake, NY (US)

(21) Appl. No.: 14/489,046

(22) Filed: Sep. 17, 2014

(51) Int. Cl. G06Q 10/06

(52) U.S. Cl. CPC G06Q 10/06313; G06Q 10/06315

(57) ABSTRACT

Creating cross-skill training plans may be facilitated based on historical ticket data received from one or more ticketing systems. A first list of ticket categories may be identified which an agent has handled previously. A second list of ticket categories may be identified which the agent has not handled previously. For a candidate category in the second list of ticket categories, a plurality of metrics may be determined, comprising at least an importance factor associated with the candidate category and a temporal correlation between the candidate category and the first list of ticket categories. Resource utilization associated with the agent may be determined. Information comprising at least the candidate category, the plurality of metrics and the resource utilization may be presented via a computer user interface. Based on one or more criteria, a cross-skill training plan may be built.

### FIELD

The present application relates generally to computers and computer applications, and more particularly to generating cross-skill training plans for accounts in application management service, e.g., based on application management ticket data analysis.

### BACKGROUND

Application Management Service (AMS) tasks include managing application development, enhancement, testing, production maintenance and support. Effective management of application requires deep expertise, yet many companies may not find this within their core competency, especially given the large number and complexity of the applications. Consequently, companies have turned to AMS providers for assistance.

While AMS providers typically assume full responsibility for many of the application management tasks, it is the maintenance-related activities that usually take up the majority of an organization's application budget.

### BRIEF SUMMARY

A method and system that facilitate creation of cross-skill training plans based on historical ticket data may be provided. The method, in one aspect, may comprise receiving via an input device historical ticket data comprising service request and associated information from one or more ticketing systems and stored in a database. The method may also comprise identifying a first list of ticket categories which an agent has handled previously, based on the historical ticket data. The method may further comprise identifying a second list of ticket categories which the agent has not handled previously, based on the historical ticket data. The method may also comprise, for a candidate category in the second list of ticket categories, determining a plurality of metrics comprising at least an importance factor associated with the candidate category and a temporal correlation between the candidate category and the first list of ticket categories. The method may also comprise determining resource utilization associated with the agent. The method may further comprise presenting information via a computer user interface. The information may comprise at least the candidate category, the plurality of metrics and the resource utilization.

A system of facilitating creation of cross-skill training plans based on historical ticket data, in one aspect, may comprise a hardware processor. An input device connected to the hardware processor may be operable to receive historical ticket data comprising service request and associated information from one or more ticketing systems. The hardware processor may be operable to identify a first list of ticket categories which an agent has handled previously, based on the historical ticket data. The hardware processor may be further operable to identify a second list of ticket categories which the agent has not handled previously, based on the historical ticket data. For a candidate category in the second list of ticket categories, the hardware processor may be further operable to determine a plurality of metrics comprising at least an importance factor associated with the candidate category and a temporal correlation between the candidate category and the first list of ticket categories. The hardware processor may be further operable to determine resource utilization associated with the agent. A user interface may be operable to execute on the hardware processor and further operable to present information comprising at least the candidate category, the plurality of metrics and the resource utilization.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 shows the overall data process flow for facilitating a creation of cross-skill training plans based on historical ticket data or service request data in one embodiment of the present disclosure.

FIG. 2 shows an example computation for determining similarity measurement between ticket categories in one embodiment of the present disclosure.

FIG. 3 illustrates example ticket categories clustered into ticket clusters in one embodiment of the present disclosure.

FIG. 4 illustrates a scenario for identifying one or more candidate categories on which an agent may be trained in one embodiment of the present disclosure.

FIG. 5 shows an example resolution time distribution in one embodiment of the present disclosure.

FIG. 6 shows an example distribution of ticket arrival, completion and backlog over a period of time for tickets in a particular category in one embodiment of the present disclosure.

FIG. 7 illustrates an example of volume share of missed SLA by category in one embodiment of the present disclosure.

FIG. 8 illustrates an example ticket volume forecasting of a particular category, wherein the curve in the shaded region indicates the forecasted volume and the shaded area indicates the prediction confidence range in one embodiment of the present disclosure.

FIG. 9 illustrates a process of computing category importance score as the weighted sum of a plurality of measurements in one embodiment of the present disclosure.

FIG. 10 illustrates a process of training a regression model to predict a category's importance score in one embodiment of the present disclosure.

FIG. 11 shows an example list of complexity indicators that may be scored and used to determine ticket category's complexity in a tabulated format in one embodiment of the present disclosure.

FIG. 12 shows an example where category C has a high temporal correlation with a category in Ω in one embodiment of the present disclosure.

FIG. 13 shows an example where category C has a low temporal correlation with a category in Ω in one embodiment of the present disclosure.

FIG. 14 shows an example list of the metrics for different agents of an account in one embodiment of the present disclosure.

FIG. 15 shows an example plan determined based on an example criteria in one embodiment of the present disclosure.

FIG. 16 shows an example of a plan sorted based on the category importance in one embodiment of the present disclosure.

FIG. 17 shows another example plan in one embodiment of the present disclosure.

FIG. 18 illustrates a recommended action plan in one embodiment of the present disclosure, for example, according to a best practice recommendation.

FIG. 19 illustrates an example of mapping skill names and ticket categories in one embodiment of the present disclosure.

FIG. 20 is a system architecture diagram illustrating components of a present disclosure in one embodiment.

FIG. 21 illustrates a schematic of an example computer or processing system that may implement a system of facilitating cross-skill training plan generation in one embodiment of the present disclosure.

### DETAILED DESCRIPTION

A methodology of the present disclosure in one embodiment facilitates creation of cross-skill training plans, e.g., based on its historical ticket (service request) data. For example, a methodology of the present disclosure may assist AMS clients or accounts to generate effective cross-skill training plan(s), e.g., that determine who to train and what skills to train.

In one aspect, a methodology of the present disclosure determines a cross-skill training plan by analyzing a given account's service request data and identifying a set of candidate categories (which indicate skills) for each worker, e.g., account agent or consultant, to be trained upon. Based on the given account's service request data, the methodology of the present disclosure in one embodiment measures the following metrics: the importance of each such category, consultant's (or worker's) resource utilization, and the temporal correlation between such category and the categories that the consultant (e.g., worker) can already handle. A methodology in one embodiment may present all measurements to an account team allowing it to generate very flexible cross-skill training plans based on various goals.

Application-based problem tickets (also known as service requests or service request data) contain a wealth of information about application management processes such as how well an organization utilizes its resources and how well people are handling tickets and therefore captures maintenance-related activities. Analyzing ticket data becomes one of the most effective ways to gain insights on the quality of application management process and the efficiency and effectiveness of actions taken in the corrective maintenance.

Skill training is an aspect of managing an AMS client or account. Up-skill training focuses on improving peoples' existing skills, help them gain more expertise on the existing skills, and for example, improve productivity. Cross-skill training builds people's skills in new areas, aims to train people on skills that they currently do not possess. Compared to up-skilling, making cross-skilling plan may be more challenging as it needs to determine the type of skills that a person should be trained upon as well as determining who needs to be trained, e.g., under a constrained training budget. Improving skills can improve the overall account performance. For AMS account management, an automated way of determining cross-skill training plans is very useful, for example, due to the continuously changing service catalogs.

Given an account's ticket data, a methodology of the present disclosure in one embodiment applies clustering techniques to cluster ticket categories that require similar problem-solving skills into a group. The methodology in one embodiment also identifies ticket categories that suggest skills a consultant to be trained upon. The methodology in one embodiment measures the importance of each such category based on various decision factors, as well as its temporal correlation with the categories that the consultant is already handling. The methodology in one embodiment may further measure his utilization based on ticket effort data. The methodology in one embodiment may fuse all above information, along with other possible data sources such as organization structure/band, rank and training cost data, and recommend flexible yet effective cross-skill training plans for account consultants.

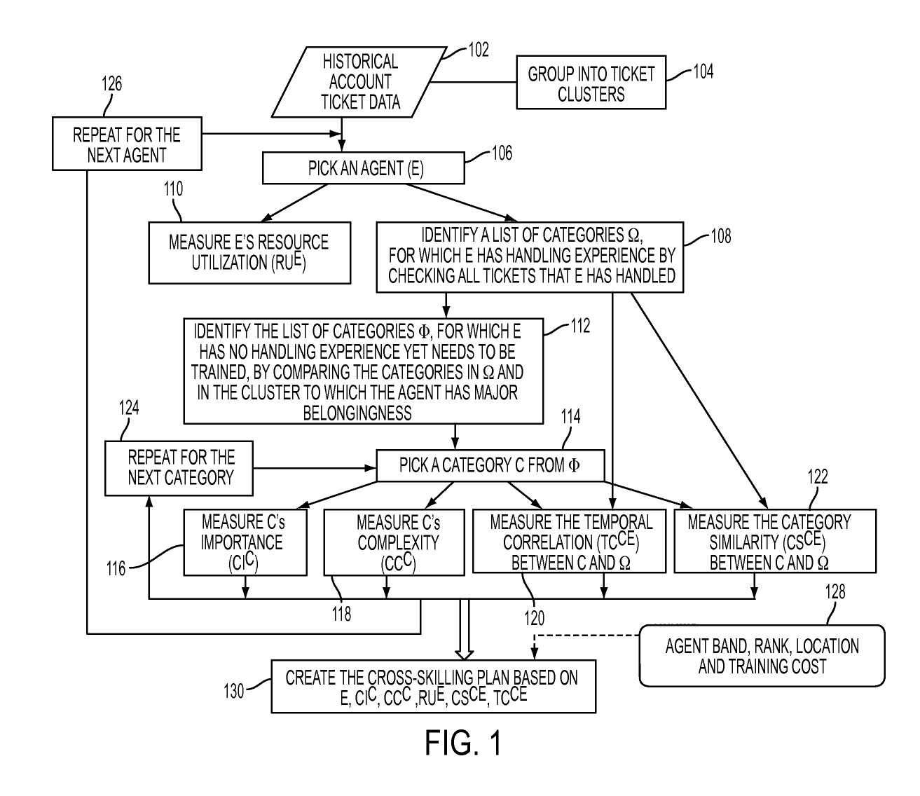

FIG. 1 shows the overall data process flow for facilitating and/or generating of cross-skill training plans based on historical ticket data or service request data. The description uses AMS account tickets as an example, however, it should be understood that any other ticket or service request may apply.

The methodology of the present disclosure in one embodiment uses ticket (service request) data as a data source. Such ticket data is recorded in ticketing systems, e.g., used by an AMS account. A service request is usually related to production support and maintenance (e.g., computer or information systems application support), computer application development, enhancement and testing. A service request is also referred to as a ticket. A ticket has multiple attributes. The actual number of attributes varies with different accounts depending on the ticket management tool as well as the way ticket data is recorded. The following attributes are example attributes that the ticket data of an account has and contain the corresponding information about each ticket. Other attributes may be included in a ticket, and/or some of the attributes may be omitted from a ticket.
1. Ticket number, which is a unique serial number.
2. Ticket status, such as open, resolved, closed or other in-progress status.
3. Ticket open time, which indicates the time when the service request is received and logged.
4. Ticket resolve time, which indicates the time when the ticket problem is resolved.
5. Ticket close time, which indicates the time when the ticket is closed. A ticket is closed after the problem is resolved and the client has acknowledged the solution.
6. Ticket severity, such as critical, high, medium and low. Ticket severity determines how a ticket should be handled. For instance, critical and high severity tickets may need to be immediately handled no matter when they arrived. Different SLAs (Service Level Agreement) could be defined for different severity levels. For instance, it may require that all critical tickets be resolved within 2 hours, and all high severity tickets be resolved within 4 hours.
7. Ticket type, which indicates the type of service request. The values can vary with different accounts.
8. Ticket category, which indicates a specific module within a specific application that likely have the problem reported by the ticket. To some extent, the ticket category indicates the skills needed to handle the ticket. The ticket data may include several ticket categories, e.g., in a hierarchical manner, e.g., indicating modules, sub-modules and sub-sub-modules.
9. Assignee, which is the name (or the identification (e.g., ID number)) of an agent or consultant who handles the ticket.
10. Assignment group, which indicates the team to which the assignee belongs.

In addition to the above 10 attributes, there may be some other attributes that share additional information about the tickets, for instance, information about each ticket's SLA observance status and assignees' geographical locations.

The methodology of the present disclosure in one embodiment uses ticket category to indicate the specific skill required for handling a ticket, e.g., to determine what skill an agent needs to handle or resolve a ticket. The methodology in one embodiment follows an approach of assuming that ticket attributes indicate (e.g., stand for) the skill needs.

In another embodiment, the methodology of the present disclosure may use a skill set information, e.g., agents or consultants' skill set information. Global data sources may be accessed for skill information. However, Ticketing systems usually do not keep a record of which skill of the consultant was relevant in resolving each ticket that the consultant handled.

Referring to FIG. 1, given the historical account ticket data 102, a methodology of the present disclosure in one embodiment identifies categories that suggest skills for a particular agent or consultant (E) to be trained upon. At 104, based on the ticket data 102, ticket categories are identified that are correlated through handling resources, and clustered into the same group using a clustering approach. Categories that are in the same group thus require similar problem-solving skills The processing at 104 may take place off-line or as a preprocessing step.

The ticket category indicates a specific application module which presents the reported problem. A methodology in one embodiment of the present disclosure uses such category to indicate the specific skill(s) required for handling the ticket. Given ticket data, the methodology of the present disclosure in one embodiment may apply a clustering approach to group together all categories that require similar or related skills In particular, the methodology of the present disclosure in one embodiment may derive the similarity or correlation between categories based on the statistics that they are handled by the same agents or consultants.

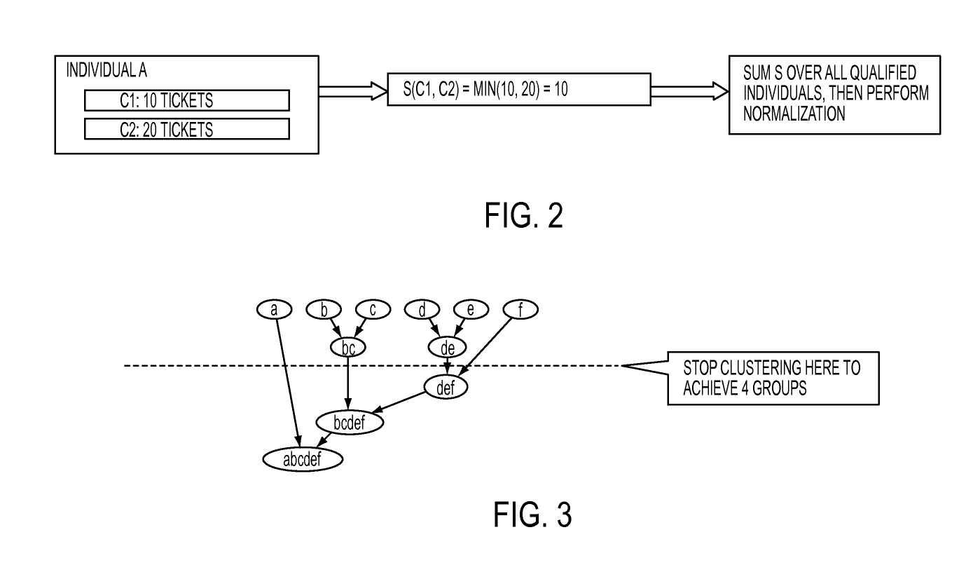

For example, the following algorithm may be used to compute a similarity measurement between two categories: For every two categories C1 and C2, the methodology of the present disclosure in one embodiment may define two parameters R and S. R represents the number of shared resources; S represent a scale of resource sharing, which determines the degree of resource sharing between the two categories. FIG. 2 shows the computation of S. Individual A for example may have a history of handling 10 tickets in C1 category and 20 tickets in C2 category. In this example, scale of resource sharing of C1 and C2, S(C1, C2), is computed as minimum of the number of tickets handled in each category, min(10, 20)=10. Overall S value (Sum S) is computed as a sum over all qualified individuals. The summed value may be normalized. The similarity measurement between the categories, e.g., C1 and C2, is calculated as multiplication of R and S, R×S. Based on the computed similarity measurement, the categories may be clustered using a clustering algorithm. One example of a clustering algorithm is agglomerative clustering. Other clustering algorithms may be utilized to cluster the ticket categories into clusters. FIG. 3 illustrates ticket categories clustered into ticket clusters. For example, ticket categories may include a, b, c, d, e, f. A clustering algorithm may group categories b and c together, categories d and e together, in a first iteration. Thus, in the first iteration, categories are clustered into groups a, bc, de and f. In the next iteration, the clustering algorithm may group cluster de, and ticket category f together to form a cluster def. In the next iteration, the clustering algorithm may group clusters bc and def together. Yet in another iteration, the clustering algorithm may group ticket category a with cluster bcdef, to form a cluster that contains ticket categories abcdef. One or more criteria or conditions may be configured to stop the clustering iterations. An example criteria may specify a threshold on the number of groups or clusters, a minimum number or maximum number of clusters, for example, when the clustering algorithm groups the ticket categories into four groups, stop clustering. The clustering of the ticket categories may be performed using historical ticket data (e.g., of a particular AMS account or another database of ticket data), and the clusters may be periodically updated based on additional ticket data that may be obtained over time. In the present disclosure in one embodiment, it is reasoned that the ticket categories grouped into the same cluster generally require similar skills

At 106, a candidate agent is selected. For agent or consultant E, a methodology of the present disclosure in one embodiment at 108 identifies all categories (denoted as Ω, and also referred to as a first list of categories) with which the agent has handling experience by checking all tickets that E has handled over time. A cluster (group of ticket categories) to which the agent has the largest belongingness is also identified. For the list of categories within the identified cluster also, the methodology of the present disclosure in one embodiment at 112 may identify those with which E does not have any ticket handling experience by comparing the categories in Ω and in the identified cluster. This list is denoted by Φ, and also referred to as a second list. The methodology of the present disclosure in one embodiment may recommend E to be trained for categories in Φ.

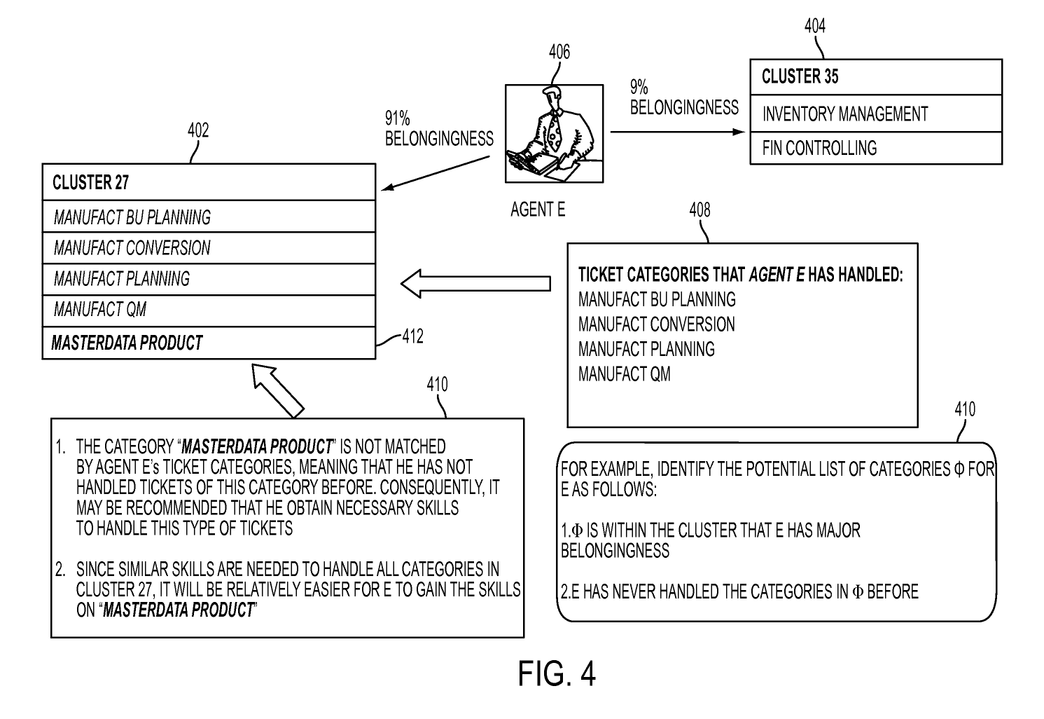

The processing at 106 and 108 identifies candidate categories in which an agent (a candidate agent) may be trained. FIG. 4 illustrates a scenario for identifying such one or more candidate categories. Take for example, a candidate agent, agent E 406. Ticket category clusters at 402 and 404 are identified that contain ticket categories that agent E 406 has handled. If there are more than one ticket cluster identified with the agent, to select a representative ticket category cluster for the agent, e.g., agent E 406, a ticket category cluster to which agent E 406 has the largest belongingness may be selected. The largest belongingness may be determined by the number of tickets the agent has handled that are in the categories contained in the cluster. So for example, if the agent handled more tickets in the categories of a first cluster than those in a second cluster, then the agent has larger belongingness to the first cluster. In the example shown in FIG. 4, agent E has larger belongingness to the cluster at 402. Continuing with the example, also consider that agent E has handled tickets in categories listed at 408. Comparing the list of categories in the cluster at 402 with the list of categories that agent E has handled, it is determined that agent E has not handled tickets in ticket category, “masterdata product.” This is shown at 410. For example, the category “masterdata product” is not matched by Agent E's ticket categories, meaning that he has not handled tickets of this category before. Consequently, it may be recommended that he obtain necessary skills to handle this type of tickets. In one aspect, since it is presumed that similar skills are needed to handle the categories in a cluster, e.g., Cluster 27 shown at 402, it may be relatively easier for agent E to gain the skills for addressing “masterdata product” category.

The list of categories which the agent has not handled previously may include more than one category. For instance, as shown at 412, Φ may include one or more categories in which the agent may be trained, i.e., one or more skills A category may be selected from this list of categories, based on one or more factors, for instance, if the list (Φ) includes more than one category. In another aspect, the list of those categories may be ranked based on one or more factors.

Referring back to FIG. 1, for a category in the list of categories that the agent has not handled previously, the following measurements may be computed, and based on one or more of those measurements, it may be determined whether that category is one on which the agent is to be trained.

At 114, a category C is selected from Φ.

At 116, ticket category C's importance (CI^{C}) is measured. For instance, the list of categories in Φ may be ranked or prioritized based on one or more criteria. One criteria may be an importance indication of a category, e.g., relative to the rest of the categories in the list. The more important the category, the higher may be the priority in terms of skill training. The processing at 116 measures the importance of each category C in set Φ based on various decision factors. If a category is highly important, it should be given a higher priority when deciding “what to train” for agent or consultant E. In one embodiment, the methodology of the present disclosure may derive such category importance from the following perspectives: A category could be important if it is in a critical state, thus deserving immediate attention. This is called the criticality perspective; A category could be important if it is among those popular or major categories. This is called the popularity perspective.

In one embodiment, category C's criticality may be measure based on the following metrics: average resolution time, backlog status, gap between estimated full-time equivalent (FTE) for category C and its actual number of workers, and percentage of tickets of C that have breached a service level agreement (SLA). One or combinations of two or more of the metrics may be used.

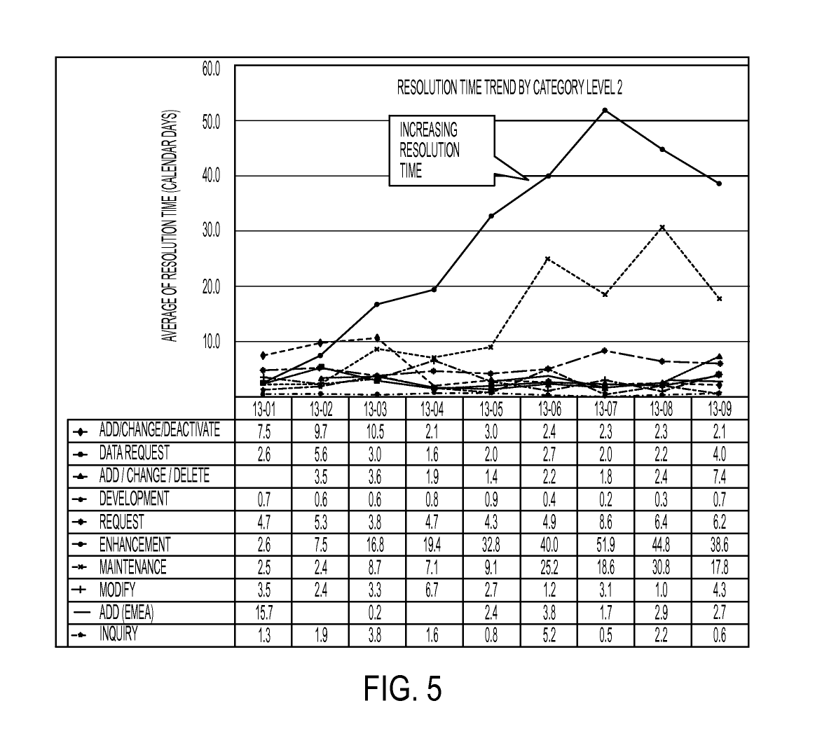

Average resolution time. Resolution time is defined as the amount of elapsed time between a ticket's open time and close time. A large resolution time on C indicates that tickets of this category are not handled fast enough, which might be due to the inexperience or lack of skills of the people. Consequently, the account could consider training more people to handle this category. FIG. 5 shows an example resolution time distribution. The figure shows that in particular category (e.g., Enchancement), resolution time has been on rise all the time. Such increase in the resolution time may trigger an attention. For normalization purpose, the methodology of the present disclosure in one embodiment may divide category C's average resolution time by the largest resolution time of all categories.

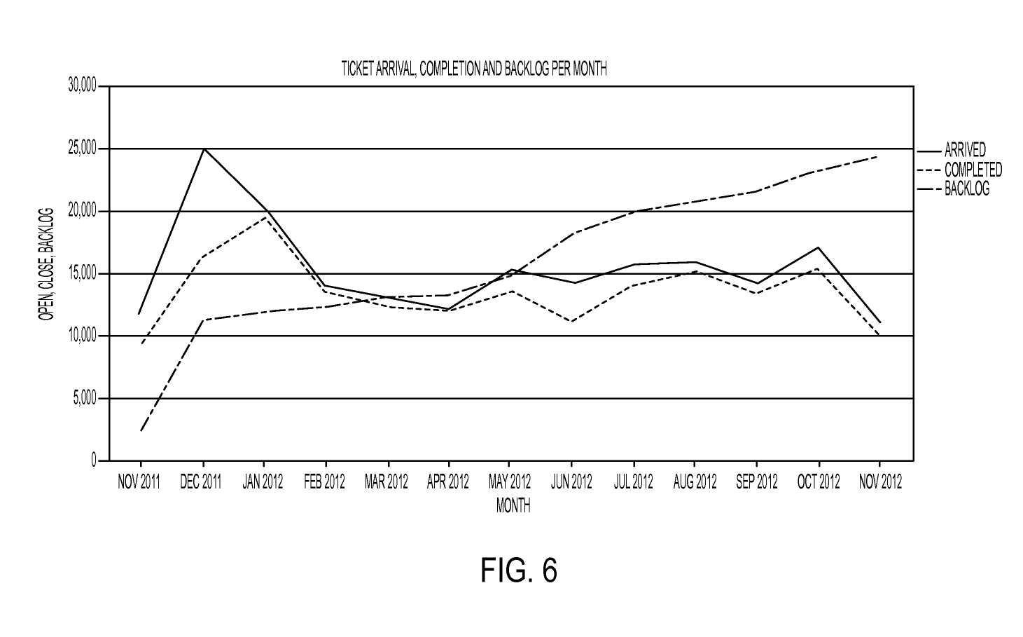

Backlog status. Backlog refers to the number of tickets that are placed in queues and have not been processed in time. Backlog may be calculated as the difference between the total numbers of arriving tickets and resolved tickets within a specific time window (e.g., September 2013), plus the backlogs carried over from the previous time window (e.g., August 2013). A large backlog on category C indicates that its ticket completion has not been able to catch up with its ticket arrivals. This could be due to insufficient staffing or incapability of staffs on handling C. Consequently, the account could consider training more people to handle this category. FIG. 6 shows an example distribution of ticket arrival, completion and backlog over a period of time for tickets in a particular category. The figure shows that the backlog has been increasing all the time. For normalization purpose, the methodology of the present disclosure in one embodiment may divide the accumulated backlog of category C by its total ticket volume.

Worker gap. Worker gap refers to the gap between the actual number of worker and the FTE (full-time equivalent) estimated based on workload. In one embodiment, based on the ticket volume, severity and account's SLA definition, the methodology of the present disclosure may apply a queuing model to estimate the FTE requirement for category C. If a large gap is identified meaning that the existing number of worker is much less than what is required to properly handle tickets, the account should consider training more people to handle this category. For normalization purpose, the methodology of the present disclosure in one embodiment may divide the worker gap by either C's worker number or its FTE estimate, whichever is larger.

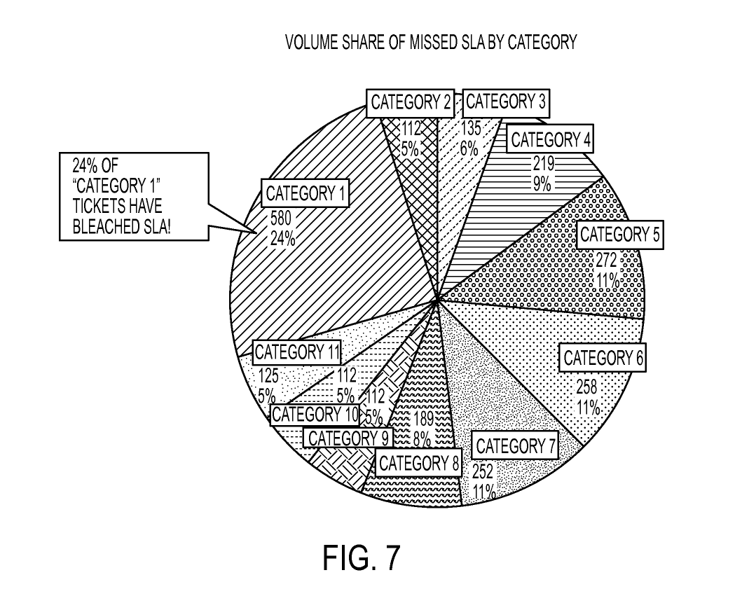

SLA breach rate. SLA breach rate refers to the percentage of tickets that have breached an SLA. For instance, if a ticket of critical severity was resolved within 10 hours, yet it should have been resolved within 4 hours as required by an SLA, this ticket has breached the SLA. SLA breach is usually due to either insufficient staffing or the incapability of staffs. Once an account's breach rate is above a certain threshold, it could be penalized with fines. Consequently, if a large SLA breach rate is identified with category C, the account should consider training more people to handle it. FIG. 7 illustrates an example of volume share of missed SLA by category.

Large resolution time, increasing ticket backlog, a positive worker gap, and a large SLA breach rate indicate the need of more help in category C, and therefore attribute higher importance to category C with respect to training more people to handle it.

In one embodiment of the present disclosure, C's importance measure may also take into account category C's popularity measure. A popularity measure may be computed based on the following metrics in one embodiment of the present disclosure: volume share with respect to all tickets, volume share with respect to critical/high severity tickets, and forecasted volume.

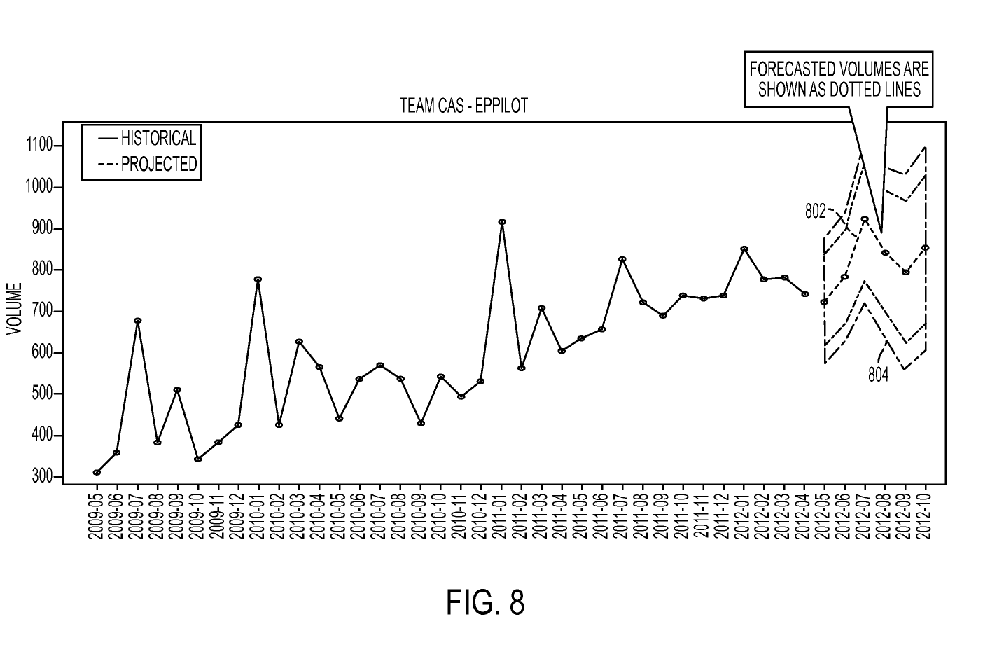

Volume share with respect to all tickets indicates the proportion of tickets belonging to C. Volume share with respect to critical/high severity tickets indicates the proportion of critical/high tickets belonging to C. Forecasted volume refers to the predicted ticket volume for future period of time, e.g., future weeks or months in a short to medium term. Given historical ticket volumes, various time series forecasting models can be applied to achieve this, such as ARMA (autoregressive moving average) model and ARIMA (autoregressive integrated moving average) model. FIG. 8 shows an example of forecasting ticket volume for a particular category, where the curve (in the shaded area) at 802 indicates the forecasted volume. The shaded area 804 indicates the prediction confidence range. From the figure, it can be seen that the forecasted volume has continued the increasing trend over the past three years. For normalization purpose, the methodology of the present disclosure in one embodiment may convert this metrics into forecasted volume share.

Large ticket volumes, high volumes of critical or high severity tickets, and large or increasing forecasted volumes may all indicate the importance of category C, and therefore, it may be recommended that more people be trained in the skills associated with the category.

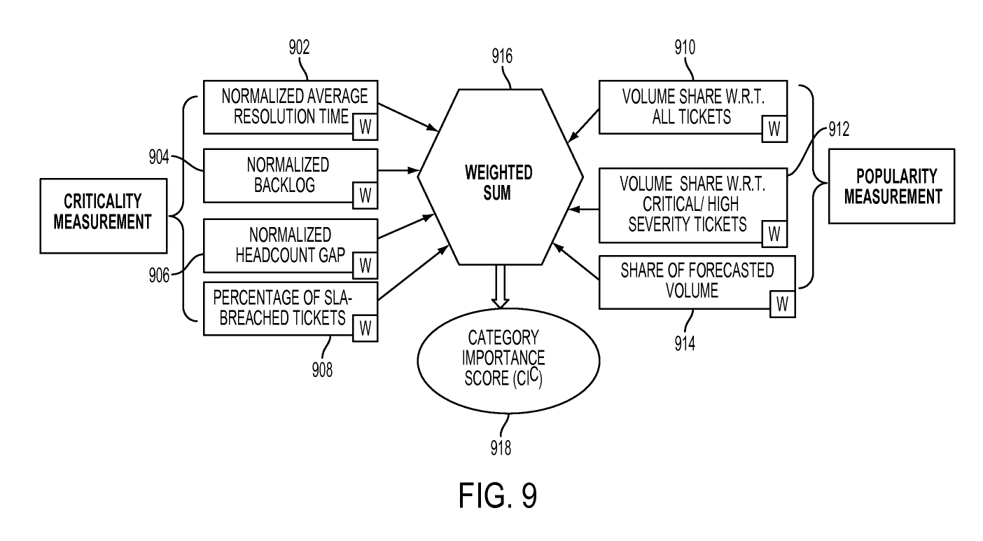

The methodology in one embodiment of the present disclosure may measure category C's importance score (CI^{C}) based on the aforementioned metrics. Different approaches can be applied to determine the importance score. One approach (referred to as a first approach) assigns CI^{C} to be the weighted sum of a plurality of the measurements (e.g., above described average resolution, backlog, worker gap, percentage of SLA-breached tickets, volume share with respect to all tickets, volume share with respect to critical/high severity tickets, share of forecasted volume) after they have been appropriately normalized. FIG. 9 illustrates a process of computing category importance score as the weighted sum of a plurality of measurements in one embodiment of the present disclosure. The methodology of the present disclosure in one embodiment may normalize each measurement into the range of [0, 1], e.g., if necessary. For example, average resolution time of C 902 can be normalized by the largest average resolution time of all categories. The accumulated backlog of C 904 can be normalized by C's total ticket volume. The worker gap 906 can be normalized by C's FTE estimate or number of worker (whichever is larger). The forecasted volume 914 can be converted into a volume share.

The methodology of the present disclosure in one embodiment sums the measurements with weights 902, 904, 906, 908, 910, 912, 914 as shown at 916 to determine a category importance score 918. The weight of each measurement, e.g., can be preset or learned from labeled data. In one aspect, all of the seven measurements may be summed. In another aspect, some of the measurements may be utilized.

Another approach (referred to as a second approach) uses multiple linear regression to compute the importance score for C. In this case, the set of (e.g., seven) measurements form the exploratory variables, while the category importance score is the dependent variable. To collect the training data, the methodology of the present disclosure in one embodiment may calculate the seven metrics for each category, then manually decide its importance score or calculate it as their weighted sum followed by some necessary adjustment. Once sufficient amount of training data is obtained, a regression model may be built. Given a set of seven measurements of category C, the methodology of the present disclosure in one embodiment may use this model to predict its importance score.

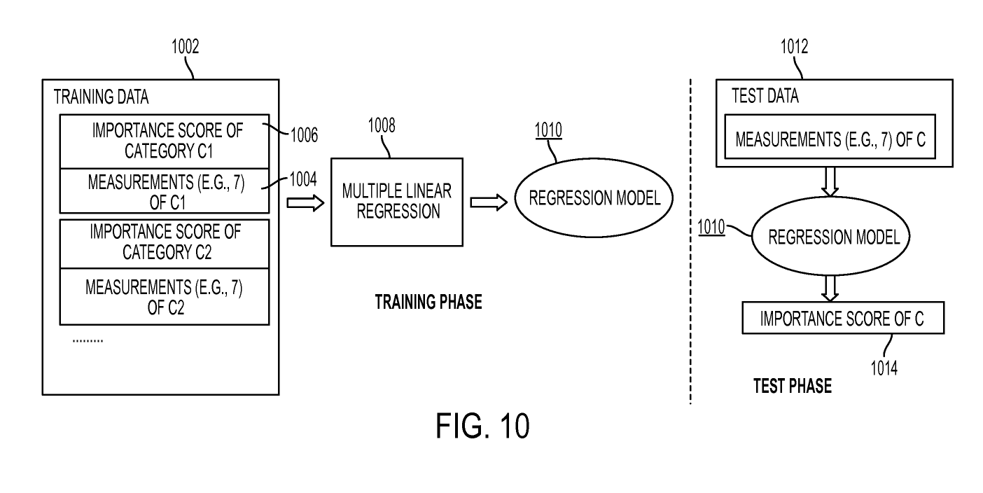

FIG. 10 illustrates a process of training a regression model to predict a category's importance score in one embodiment of the present disclosure. The training data 1002 may be prepared as follows in one embodiment of the present disclosure. For every category, the methodology of the present disclosure in one embodiment may normalize each of its measurements (e.g., average resolution, backlog, worker gap, percentage of SLA-breached tickets, volume share with respect to all tickets, volume share with respect to critical/high severity tickets, share of forecasted volume) 1004 into a range of [0,1], if necessary; then the methodology of the present disclosure in one embodiment may then assign an importance indicator to it 1006 (e.g., every category). Such importance indicator can be either manually picked, or calculated and adjusted based on the weighted sum as explained above. One or more domain experts or subject matter experts, e.g., may provide such indicators or weights. The measurements 1004 form the set of explanatory variables, and the importance score is the dependent variable. To collect a sufficient amount of training data, ticket data from a longer period of time of the same account may be collected and analyzed. The methodology of the present disclosure in one embodiment conducts the multiple linear regression based on training data at 1008 and build the regression model 1010. Given a set of measurements associated with a category (e.g., category C) 1012, the methodology of the present disclosure may apply the regression model 1010 to compute or determine the importance score for that category (e.g., category C) 1014.

In statistics, linear regression is an approach to model the relationship between a scalar dependent variable y and one or more explanatory variables denoted by X. When X has more than one explanatory variable, it is called multiple linear regression. In linear regression, data are modeled using linear predictor functions, and unknown model parameters are estimated from the data. Linear regression often refers to a model in which the conditional mean of y given the value of X is an affine function of X.

Referring back to FIG. 1, at 118, the complexity of ticket category C in Φ (CC^{C}) is measured. To some degree, the complexity of a category determines how hard it is for an agent or consultant to master the skill to handle it, and consequently, how long such skill-training will take. A methodology of the present disclosure in one embodiment may take this dimension into account in generating a cross-skill training plan. Ticket complexity can be manually determined (e.g., by ticket dispatcher if possible), or automatically measured based on various factors. To measure the complexity of a given ticket category, the methodology of the present disclosure in one embodiment may collect indicators of its complexity from various of aspects, e.g., number of in/out-bound interface, known design issues, average ticket effort, etc. Then the methodology of the present disclosure in one embodiment may assign a different score to each individual indicator, e.g., based on domain and field operation knowledge. All indicator scores may be fused together to produce one single score, which signals the complexity of the given ticket category. Different fusion mechanism can be applied here. Examples include simple sum and normalization, weighted average, clustering, etc.

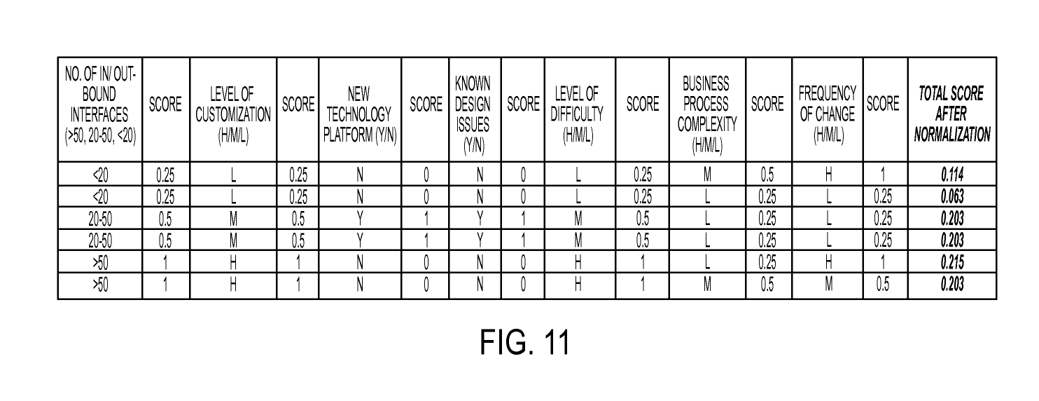

Example of complexity indicators may include but are not limited to Number of in/out-bound interfaces, Level of customization, Technology platform, Known design issues, Level of difficulty, Business process complexity, Frequency of update/enhancement, Average ticket effort. FIG. 11 shows an example list of complexity indicators that may be scored and used to determine ticket category's complexity in a tabulated format in one embodiment of the present disclosure. The columns show the complexity indicators with associated scores; the rows show sample categories.

Referring to FIG. 1, at 120, temporal correlation between ticket category C and ticket categories in Ω is measured (TC^{CE}). Given C which indicates a category recommended to be trained for agent or consultant E, a methodology of the present disclosure in one embodiment may measure the temporal correlation between C and the categories that E is already capable of handling (denoted by Ω), e.g., in terms of their ticket arriving patterns. If the arrivals of category C tickets are highly correlated with those of categories in Ω, since they overlap in time, it is very likely that when tickets of category C arrive, E is busy handling tickets of categories in Ω, thus the agent may not have the bandwidth to handle them. In this case, training E to handle category C may not bring much benefit. In contrast, if such correlation is low, when category C tickets arrive, E likely does not have category Ω tickets to handle, consequently the agent is able to handle them.

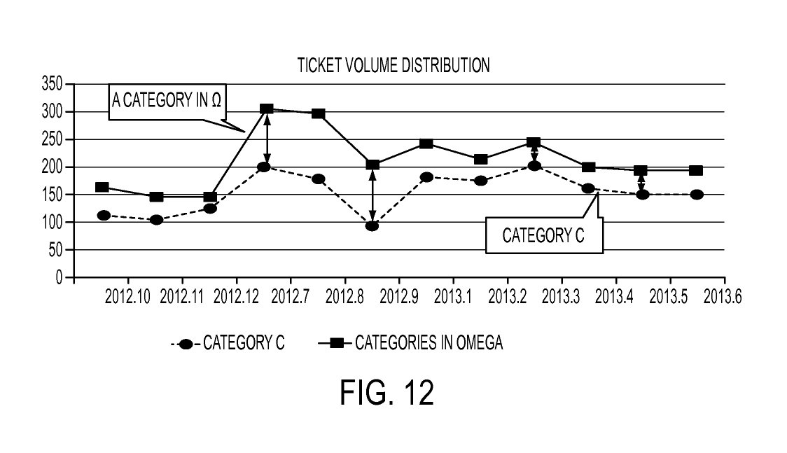

FIG. 12 shows an example where category C has a high temporal correlation with a category in Ω. The figure shows high temporal correlation between arrivals of category Ω tickets and category C tickets. Specifically, as indicated by the arrows, when category C reaches a local maximum or minimum, so does the other category. Such temporal synchronization may result in inefficient ticket handling scenario since it increases E's workload with category C tickets when he or she is already busy with category Ω tickets. On the other hand, when E gets a break from Ω tickets, there are no C tickets for him to work on either.

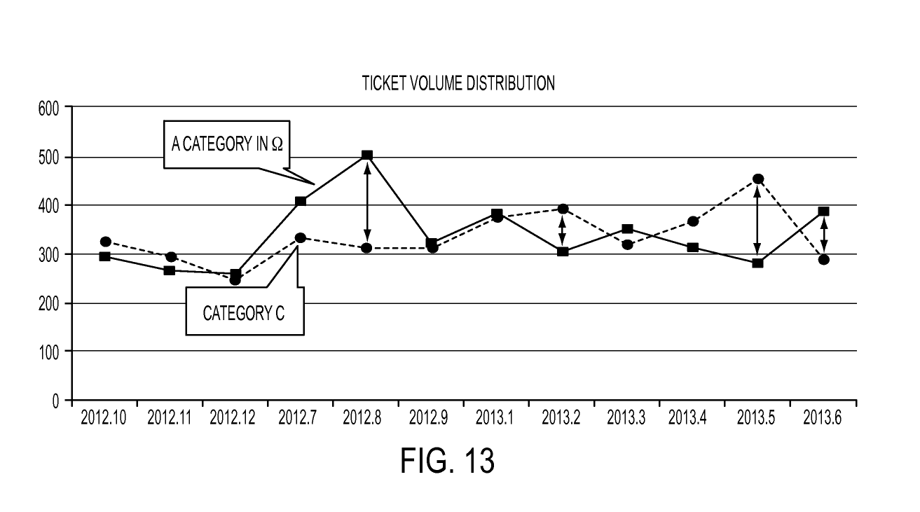

FIG. 13 shows an example where category C has a low temporal correlation with a category in Ω. The figures shows low temporal correlation between arrivals of category Ω tickets and category C tickets. Specifically, as indicated by the arrows, when category C reaches a local maximum or minimum, the other category reaches a local minimum or maximum, respectively. This results in an efficient ticket handling scenario since E may be able to handle C tickets and Ω tickets at different times. Consequently, training E to handle tickets of category C may be beneficial.

To measure the temporal correlation between two categories, a methodology of the present disclosure may use the Pearson correlation measurement. In statistics, Pearson correlation is a method to measure the linear correlation (dependence) between two variables X and Y, giving a value between +1 and −1 inclusive, where 1 indicates positive correlation, 0 is no correlation and −1 is negative correlation. Given statistical samples of X and Y, where X={x₁, . . . xₙ}, Y={y₁, . . . , yₙ} and n is the sample size, the Pearson's correlation coefficient r is measured as

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {( {y}_{i} - \overline{y} )}^{2}}} . \qquad ( 1 )$$

In another embodiment, a methodology of the present disclosure may measure the temporal correlation between two categories using Cosine Similarity, which measures the similarity between two vectors (A and B) of an inner product space that measure the cosine of the angle between them. Thus, it is a judgment of orientation and not magnitude. Cosine Similarity is given by, e.g.,

$$similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad ( 2 )$$

To calculate the temporal correlation between C and Ω for an agent or consultant E (denoted by TC^{CE}), the methodology of the present disclosure may measure the correlation between C and every category ω in Ω (denote by r_{C,ω}), then assign TC^{CE} as their maximum, e.g.,

TC^{CE}=max(r_{C,ω}), where ω∈Ω. (3)

Referring to FIG. 1, at 122, category similarity (CS^{CE}) between ticket category C and ticket categories in Ω is measured. In one aspect, agents tend to have skills that are similar to each other (e.g., programming skills in Java, C++, etc.). In another aspect, it is generally easier for one to master a new skill that is similar to existing skills (e.g., if someone already knows about C++, it'll be easier for that someone to learn Java). A methodology of the present disclosure in one embodiment may measure the similarity between category C and the list of categories that E is already handling (Ω). Specifically, if the similarity is large, then it indicates that it may be generally easier and thus faster for E to master the skills to handle C. If the similarity is small, then it indicates that it could be hard and thus slower for E to master the skills to handle C. To measure the similarity between C and E's category set Ω, the following processing may be performed: For each category ω within Ω, the methodology of the present disclosure in one embodiment may measure the total number of agents or consultants that have handled both categories C and ω (denote it by PC(C, ω)). A larger number of PC(C, ω) indicates that there are many people who are skilled in both C and ω, thus the higher the possibility that they are similar to each other. The methodology of the present disclosure in one embodiment designates CS^{CE} as follows. The methodology of the present disclosure in one embodiment may further normalize it by dividing the total number of agents (e.g., account agents).

CS^{CE}=max(PC(C, ω)), ω∈Ω

As shown at 124, the processing at 116, 118, 120 and 122 may be performed for next category in Φ. Thus, for example, the measurements may be obtained for each category in Φ.

At 110, E's resource utilization may be measured. Resource utilization indicates how time has been utilized in handling tickets. In one embodiment, resource utilization (RU) may be measured as:

RU=(Ticket_Effort+Development_Effort)/Total_Capacity

where Ticket_Effort represents the total amount of effort (e.g., time) spent on handling tickets, determined based on one or more metadata models. For example, an equal time-share rule may be applied to calculate time spent on each ticket which assumes that an agent will spend the equal amount of time on each of the tickets which have temporal overlap between their open time and resolve time. Development_Effort represents the total amount of effort (e.g., time) spent on development and enhancement work, if any, which may be obtained from an account, e.g., AMS account.

As shown at 126, the processing at 106, 110, 108, 112, 114, 116, 118, 120, 122, 124, may be performed for next agent. Thus, for example, the measurements may be obtained for a plurality of agents.

At 130, a cross-skilling plan is generated based on the agent and measurements determined at 110, 116, 118, 120, 122. The cross-skilling plan generation may also take into account one or more factors 128 such as agent band, rank, location and training cost.

For example, based on the obtained metrics for each agent or consultant (E), for instance, the importance score of each recommended category C (CI^{C}), agent's resource utilization (RU^{E}),the temporal correlation between C and agent's existing categories Ω (TC^{CE}), C's complexity (CC^{C}) and category similarity (CS^{CE}) between C and Ω, various cross-skill training plans may be created.

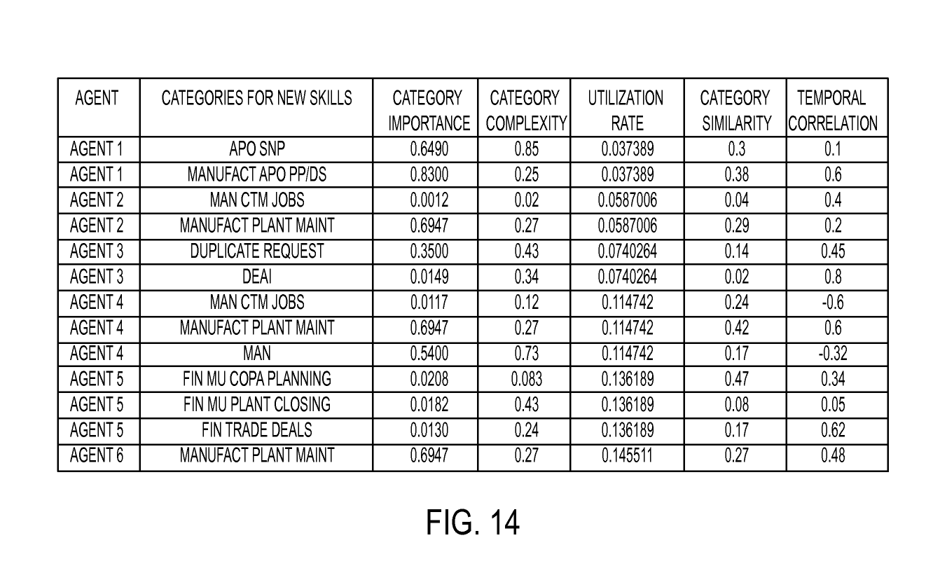

FIG. 14 shows an example list of the metrics for different agents of an account. A methodology of the present disclosure in one embodiment may also derive the training cost for each data row, which is likely a function of organization structure/band/rank, location and the category. In another aspect, they can be manually determined by an account team. All those information may form the foundation of making various skill training plans with different purposes. For example, a methodology of the present disclosure in one embodiment may receive one or more criteria and based on the criteria, determine a training plan.

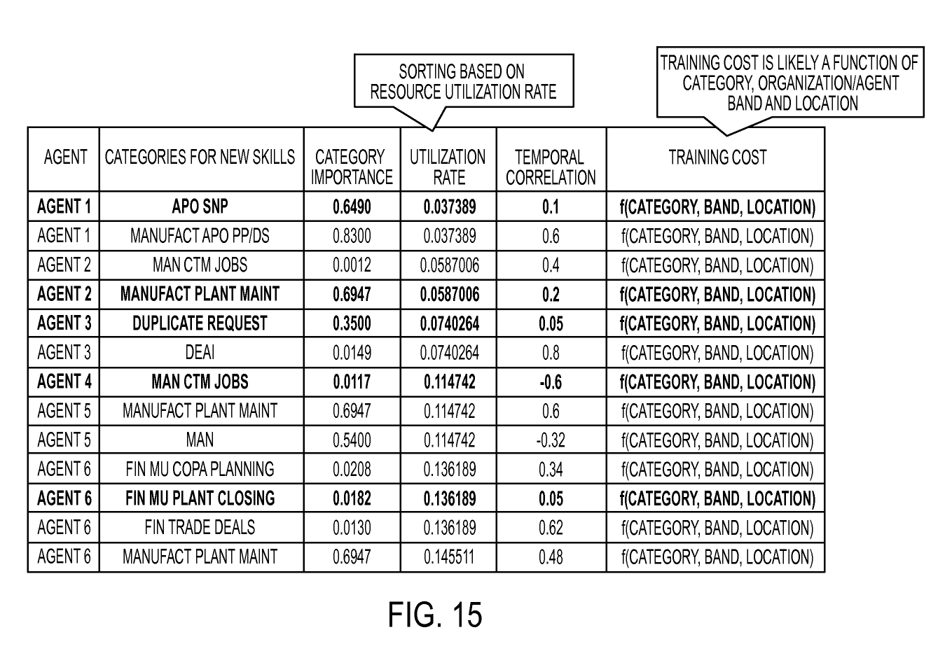

For instance, if the training goal or criteria is to “train people to improve their utilization, and also to train as many people as possible with a fixed budget”, then a methodology of the present disclosure may sort the table (information shown in the table) based on resource utilization rate, and use the training cost as the secondary sorting criterion, both in ascending orders. The top rows of distinct agents whose training cost sum up to the given budget may be returned as a solution set. FIG. 15 shows an example plan determined based on this example criteria where the selected agents are highlighted in bold font.

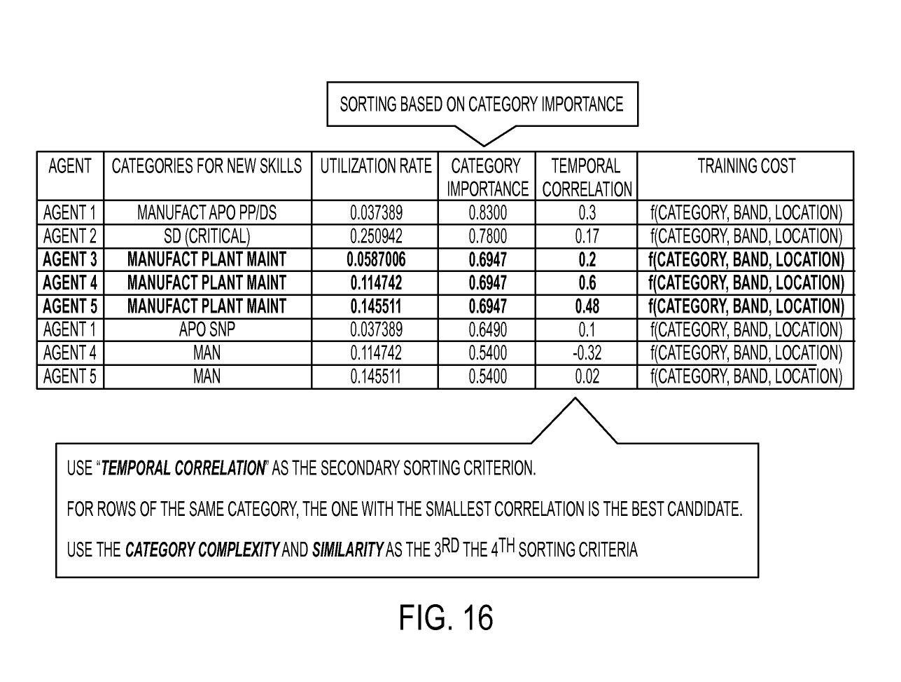

As another example, a training goal or criteria may include, “train more people to be skilled in important categories.” A methodology of the present disclosure in one embodiment may sort the information based on category importance in descending order and select top agents or consultants whose total training cost will be within the budget. FIG. 16 shows this example, where the consultants have been sorted based on the category importance. In the figure, the category “Plant Maintenance” has been recommended for three consultants (Agent 3, Agent 4 and Agent 5). A methodology of the present disclosure in one embodiment may refer to other metrics to decide which of them should be chosen for training. For instance, Agent 3 is likely the best candidate out of the three since this agent has the lowest utilization rate and the temporal correlation between the category “Plant Maintenance” and the agent's own categories is smallest (0.2). In contrast, the temporal correlation for either Agent 4 or Agent 5 are larger. Consequently, Agent 3 may be chosen to handle this category. Other metrics may be also used for planning, for example, category complexity and similarity.

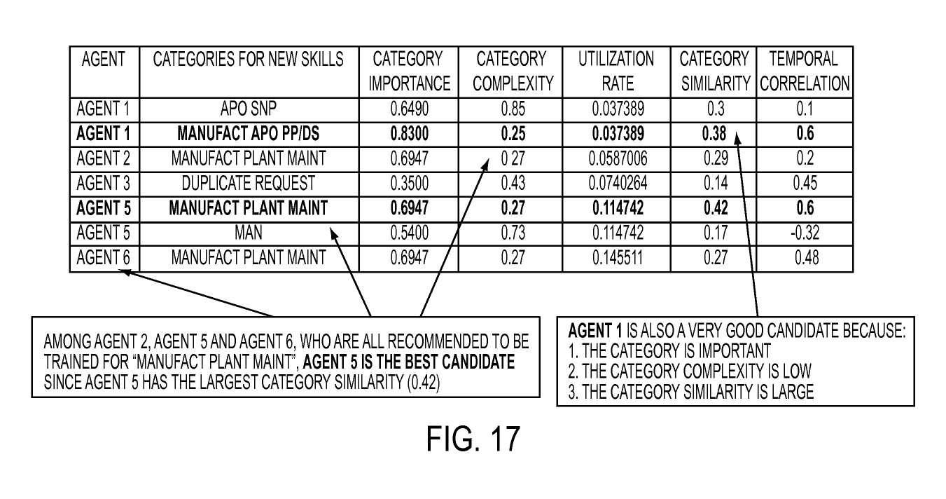

FIG. 17 shows another example plan. In this figure, the criteria specified may be to have more people to be skilled in important categories, as fast as possible. In this scenario, metrics such as category similarity and category complexity may be utilized to determine a plan. Among Agent 2, Agent 5 and Agent 6, who are all recommended to be trained for “plant maintenance”, Agent 5 is the best candidate since agent 5 has the largest category similarity (0.42). Agent 1 is also a very good candidate because agent 1's candidate category for training is important (0.83), the category complexity is low (0.25), and the category similarity is large (0.38) relative to others.

The sorting-based approach described above provides flexibility in determining training plans, for example, that can meet specific requirement and preference. For example, the training focus may be on a particular skill or category, instead of on people (for instance, “need more people to be skilled in a particular application, who are the candidates”). In this example, leaving “category importance” as a separate dimension has an advantage. As another example, the training cost could be dependent on a particular category, thus an agent is not the only decision variable. This is also true for the temporal correlation, category complexity and similarity. Thus, the sorting-based approach may be useful for training goals or criteria concerned more about certain metrics alone.

In one embodiment, a methodology of the present disclosure in one embodiment may also fuse the metrics (e.g., the five metrics or combinations of those metrics) and determine a single indicator to show how beneficial it is to train each agent or consultant. Such a single indicator may ease the job on generating the training plans.

The methodology of the present disclosure in one embodiment provides the flexibility of customizing the way to generate a plan based on their specific requirements. In one aspect, as described above, a methodology of the present disclosure in one embodiment uses ticket categories to indicate consultants' skills. In another aspect, a methodology of the present disclosure in one embodiment may take the consultants' skill data as another information source, map it to ticket categories, and integrate such analysis into the methodology.

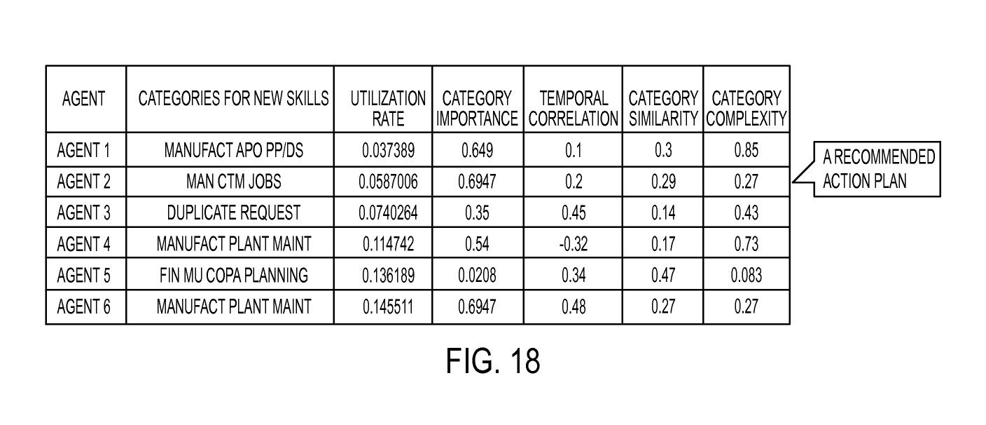

In another embodiment, a methodology of the present disclosure may provide a best practice recommendation on generating a cross-skilling plan. For instance, as a best practice, a priority order of considering the above described metrics may be provided. For example, it may be recommended to use Resource Utilization as the first criteria, as improving resource utilization may be the top priority for an account, use Category Importance as the second criteria, which means that if there are two categories recommended for the same agent, choosing the category that is more important to the account, use Temporal Correlation as the third criteria, which means that if there are two categories recommended for the same agent, choose the category that is least correlated, use Category Similarity as the fourth criteria, where the larger the similarity, the easier and faster for the training, use Category Complexity as the fifth criteria, where the lower the complexity, the easier and faster for the training. FIG. 18 illustrates a recommended action plan in one embodiment of the present disclosure, for example, according to a best practice recommendation.

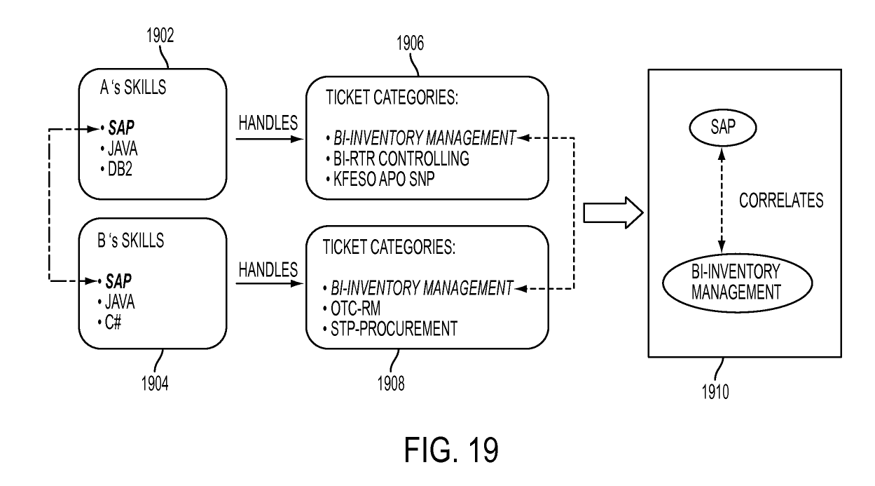

In another aspect, using available skill name or label, a methodology of the present disclosure in one embodiment may correlate skill names with the ticket categories used to represent skills For instance, category “bi-inventory management” may be associated with skill of “SAP”. For example, the methodology of the present disclosure in one embodiment may convert the categories in a generated cross-skill training plan laying out categories that are recommended for training a particular agent, into real skill names. To some degree, a skill (e.g., “SAP”) may be a superset of ticket categories which are related to different modules within the skill (e.g., “SAP”). A training plan may include ticket categories, as well as real skill names. FIG. 19 illustrates an example of mapping skill names and ticket categories. Both A's and B's skills may include “SAP” as shown at 1902 and 1904. Commonality in ticket categories handled by A and B may be determined, for example, as “bi-inventory management”, shown at 1906 and 1908. Based on the common skill shared by A and B, and common ticket category shared by A and B, a correlation may be made between the common skill and the common ticket category, e.g., as shown at 1910.

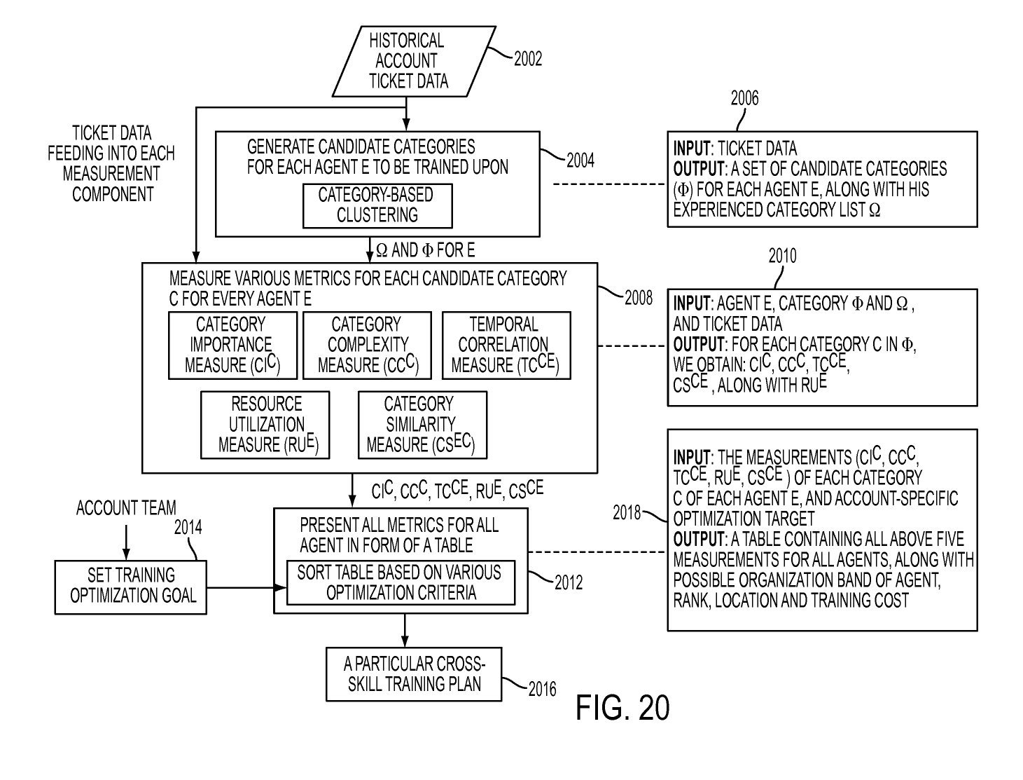

FIG. 20 is a system architecture diagram illustrating system components of a present disclosure in one embodiment that facilitate creation of cross-skill training plans based on historical ticket data, for example, for an AMS account. A hardware processor such as a central processing unit (CPU) or another processor device may run or execute one or more components or the functionalities shown in the system architecture in one embodiment of the present disclosure. An input device connected to the hardware processor may receive historical ticket data 2002 comprising service request and associated information from one or more ticketing systems. The historical ticket data 2002 may comprise large amounts of service request data, for example, data contained in thousands or more of tickets or service requests, e.g., recorded by a ticketing system continuously over a period of time.

The hardware processor may include functionality or a module 2004 that generates candidate categories for an agent to be trained upon. As shown at 2006, input to this functionality may include ticket data and output from this functionality comprise a set of candidate categories for an agent along with the agent's experienced category list. For example, in this module or functionality, the hardware processor may identify a first list of ticket categories which an agent has handled previously, based on the historical ticket data. The hardware processor may also identify a second list of ticket categories which the agent has not handled previously, based on the historical ticket data. The ticket data 2002 may be clustered into a plurality of category clusters, and the hardware processor may identify a category cluster that the agent has highest belongingness metric from the plurality of category clusters. The second list of ticket categories is identified from the identified category cluster.

In one embodiment, a module or functionality at 2008 measures various metrics for a candidate category C in the second list of ticket categories for an agent. This module 2008 may function as an engine, for example, a measurement engine. The hardware processor may perform this functionality for every candidate category C in the second list of ticket categories for every agent being considered for training. As shown at 2010, input to this functionality includes agent identity, the first and second lists of ticket categories, and ticket data. Output from this functionality may include category importance measure, category complexity measure, temporal correlation measure between the category and the first list of ticket categories, resource utilization measure, and category similarity measure, e.g., for every category in the second list of ticket categories, for every agent being considered for training.

In one embodiment, a module or functionality at 2012 presents all metrics for all agents in a form of a table for example on a computer user interface. The hardware processor performing the functionality at 2012 may receive a set of training optimization goals or one or more criteria for planning cross-skill training 2014, for example, from an account team. Based on the criteria 2014, the hardware processor may sort and/or filter the table to produce a customize cross-skill training plan 2016. As shown at 2018, input to the functionality at 2012 may include the metrics computed for category C in the second list associated with an agent and an account-specific optimization target. Output from the functionality at 2012 may include a table or like presentation containing the metrics for all agents being considered, along with possible organization band associated with the agent, rank, location and training cost. The output may also rank the measurements of category importance, category complexity, resource utilization, category similarity and temporal correlation of all identified candidate categories for all candidate agents being considered.

In one aspect, with a methodology of the present disclosure in one embodiment, there need not be a particular targeted area for each agent to be trained upon. Instead, a methodology of the present disclosure in one embodiment may recommend several categories for an agent to be potentially trained upon based on the agent's ticket-handling history. Then for each such category, a methodology of the present disclosure in one embodiment may measure its importance/criticality from various aspects. If an account team wants to train agents on particular categories, the team may quickly identify those agents based on the information a methodology of the present disclosure in one embodiment may provide. In that respect, a generalized and flexible method to generate cross-skill training plans may be provided.

In another aspect, a methodology of the present disclosure may identify agents for a particular category based on ticket data clustering, which take an agent's ticket-handling history into account. Agents' experiences on certain area may be automatically derived based on ticket data analysis. Yet in another aspect, a methodology of the present disclosure may be considered as a data-driven approach, e.g., ticket data, for example, that may be specifically tailored, for example, for AMS.

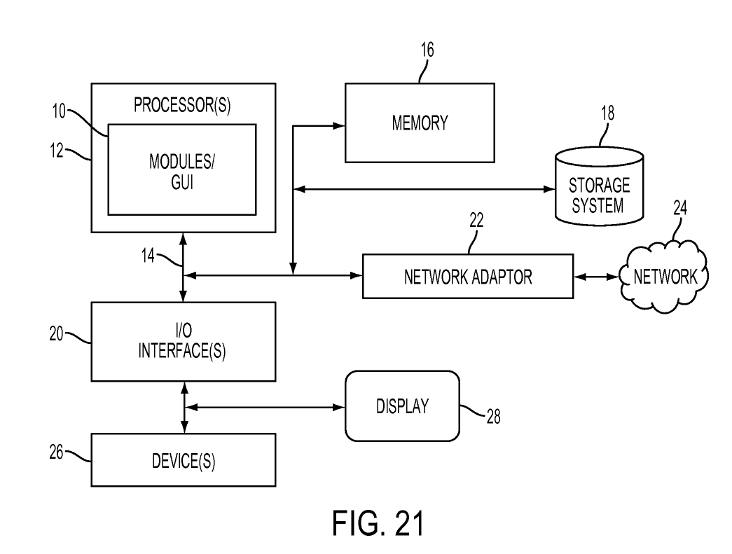

FIG. 21 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 21 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of facilitating creation of cross-skill training plans based on historical ticket data, comprising:
receiving historical ticket data comprising service request and associated information from one or more ticketing systems and stored in a database via an input device;
identifying, by a processor, a first list of ticket categories which an agent has handled previously, based on the historical ticket data;
identifying, by the processor, a second list of ticket categories which the agent has not handled previously, based on the historical ticket data;
for a candidate category in the second list of ticket categories, determining, by the processor, a plurality of metrics comprising at least an importance factor associated with the candidate category and a temporal correlation between the candidate category and the first list of ticket categories;
determining, by the processor, resource utilization associated with the agent; and
presenting, by the processor via a computer user interface, information comprising at least the candidate category, the plurality of metrics and the resource utilization.

2. The method of claim 1, further comprising generating a cross-skill training plan based on the information.

3. The method of claim 2, further comprising receiving one or more criteria and the generating a cross-skill training plan comprises generating the cross-skill training plan based on filtering and sorting the information according to said one or more criteria.

4. The method of claim 1, wherein the plurality of metrics further comprises one or more of a complexity metric associated with the candidate category, a similarity measure between the candidate category and the category in the first list of ticket categories, training cost or a combination thereof.

5. The method of claim 1, wherein the ticket data is clustered into a plurality of category clusters, and the method further comprises identifying a category cluster that the agent has highest belongingness metric from the plurality of category clusters, wherein the second list of ticket categories is identified from the identified category cluster.

6. The method of claim 1, wherein the importance factor associated with the candidate category is determined by performing a weighted sum of normalized average resolution time, normalized backlog, normalized worker gap, percentage of service level agreement breach, volume share with respect to all tickets, volume share with respect to tickets having a threshold severity, and share of forecasted volume, associated with the candidate category.

7. The method of claim 1, wherein the importance factor associated with the candidate category is determined by building a multiple linear regression model comprising normalized average resolution time, normalized backlog, normalized worker gap, percentage of service level agreement breach, volume share with respect to all tickets, volume share with respect to tickets having a threshold severity, and share of forecasted volume, associated with the candidate category, as explanatory variables, and an importance score as a dependent variable.

8. The method of claim 1, wherein said determining of the plurality of metrics are performed for a plurality of categories in the second list of ticket categories.

9. The method of claim 1, wherein said identifying of the first list of ticket categories, said identifying of the second list of ticket categories, said determining of the plurality of metrics and said determining of the resource utilization, are performed for a plurality of agents.

10. A system of facilitating creation of cross-skill training plans based on historical ticket data, comprising:
a hardware processor;
an input device connected to the hardware processor and operable to receive historical ticket data comprising service request and associated information from one or more ticketing systems;
the hardware processor operable to identify a first list of ticket categories which an agent has handled previously, based on the historical ticket data,
the hardware processor further operable to identify a second list of ticket categories which the agent has not handled previously, based on the historical ticket data,
for a candidate category in the second list of ticket categories, the hardware processor further operable to determine a plurality of metrics comprising at least an importance factor associated with the candidate category and a temporal correlation between the candidate category and the first list of ticket categories,
the hardware processor further operable to determine resource utilization associated with the agent; and
a user interface operable to execute on the processor and further operable to present information comprising at least the candidate category, the plurality of metrics and the resource utilization.

11. The system of claim 10, wherein the hardware processor is further operable to generate a cross-skill training plan based on the information.

12. The system of claim 10, wherein the hardware processor is further operable to receive one or more criteria and generate a cross-skill training plan based on filtering and sorting the information according to said one or more criteria.

13. The system of claim 10, wherein the plurality of metrics further comprises one or more of a complexity metric associated with the candidate category, a similarity measure between the candidate category and the category in the first list of ticket categories, training cost or a combination thereof.

14. The system of claim 10, wherein the ticket data is clustered into a plurality of category clusters, and the hardware processor further identifies a category cluster that the agent has highest belongingness metric from the plurality of category clusters, wherein the second list of ticket categories is identified from the identified category cluster.

15. The system of claim 10, wherein the importance factor associated with the candidate category is determined by performing one or more of:
a weighted sum of normalized average resolution time, normalized backlog, normalized worker gap, percentage of service level agreement breach, volume share with respect to all tickets, volume share with respect to tickets having a threshold severity, and share of forecasted volume, associated with the candidate category; or
building a multiple linear regression model comprising the normalized average resolution time, the normalized backlog, the normalized worker gap, the percentage of service level agreement breach, the volume share with respect to all tickets, the volume share with respect to tickets having a threshold severity, and the share of forecasted volume, associated with the candidate category, as explanatory variables, and an importance score as a dependent variable.

16. The system of claim 10, wherein the hardware processor determines the plurality of metrics for a plurality of categories in the second list of ticket categories, and
wherein the hardware processor identifies the first list of ticket categories, the second list of ticket categories, and determines the plurality of metrics and the resource utilization for a plurality of agents.

17. A computer readable storage medium storing a program of instructions executable by a machine to perform a method of facilitating creation of cross-skill training plans based on historical ticket data, the method comprising:
receiving historical ticket data comprising service request and associated information from one or more ticketing systems;
identifying a first list of ticket categories which an agent has handled previously, based on the historical ticket data;
identifying a second list of ticket categories which the agent has not handled previously, based on the historical ticket data;
for a candidate category in the second list of ticket categories, determining a plurality of metrics comprising at least an importance factor associated with the candidate category and a temporal correlation between the candidate category and the first list of ticket categories;
determining resource utilization associated with the agent; and
presenting, via a computer user interface, information comprising at least the candidate category, the plurality of metrics and the resource utilization.

18. The computer readable storage medium of claim 17, further comprising generating a cross-skill training plan based on the information.

19. The computer readable storage medium of claim 18, further comprising receiving one or more criteria and the generating a cross-skill training plan comprises generating the cross-skill training plan based on filtering and sorting the information according to said one or more criteria.

20. The computer readable storage medium of claim 17, wherein the plurality of metrics further comprises one or more of a complexity metric associated with the candidate category, a similarity measure between the candidate category and the category in the first list of ticket categories, training cost or a combination thereof.
